(19) United States
(12) Patent Application Publication
(10) Pub. No.: US 2026/0142695 A1
(43) Pub. Date: May 21, 2026

(54) COMMUNICATION METHOD AND APPARATUS, DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/120,542

(22) PCT Filed: Oct. 13, 2022
(86) PCT No.: PCT/CN2022/125195

§ 371 Date: Apr. 11, 2025

(51) Int. Cl. H04B 7/0452; H04W 76/11

(52) U.S. Cl. CPC H04B 7/0452; H04W 76/11

(57) ABSTRACT

Embodiments of the present disclosure relate to the technical field of communications, and provide a communication method and apparatus, a device, and a storage medium, which can be applied to an access point (AP) device. The method comprises: determining a first message frame, wherein the first message frame comprises a first capability information element, the first capability information element comprises first identification information, and the first identification information indicates that the AP device supports non-orthogonal frequency division multiple access (non-OFDMA) uplink (UL) multi-user multiple-input multiple-output (MU-MIMO) communication on 640 MHz bandwidth; and sending the first message frame. The embodiments of the present disclosure can provide a communication mode that indicates a bandwidth supported in non-OFDMA UL MU-MIMO communication.

### CROSS-REFERENCE TO RELATED APPLICATION

The application is a U.S. National Stage of International Application No. PCT/CN 2022/125195 filed on Oct. 13, 2022, the entire content of which is incorporated herein by reference.

### TECHNICAL FIELD

Embodiments of the present disclosure relate to the technical field of communication, and in particular, to a communication method and apparatus, a device and a storage medium.

### BACKGROUND

With the continuous development of the Wireless Fidelity (Wi-Fi) technology, researchers have proposed the next generation of Wi-Fi technology: the ultra high reliability (UHR). The vision of the UHR is to improve the reliability of WLAN connections, reduce latency, improve manageability, increase system throughput, and reduce power consumption of corresponding devices.

### SUMMARY

In a first aspect, an embodiment of the present disclosure provides a communication method, which may be applied to an access point (AP) device, and the method includes:
determining a first message frame, where the first message frame includes a first capability information element, the first capability information element includes first identification information, and the first identification information is used to indicate that the AP device supports non-orthogonal frequency division multiple access (non-OFDMA) uplink (UL) multi-user multiple-input multiple-output (MU-MIMO) communication on a 640 MHz bandwidth; and
sending the first message frame.

In a second aspect, an embodiment of the present disclosure provides a communication method, which may be applied to a station (STA) device, and the method includes:
determining a second message frame, where the second message frame includes a second capability information element, the second capability information element includes fifth identification information, and the fifth identification information is used to indicate that the STA device supports non-OFDMA UL MU-MIMO communication on a 640 MHz bandwidth; and sending the second message frame.

In a third aspect, an embodiment of the present disclosure further provides a communication apparatus, and the apparatus includes:
a first determining unit, configured to determine a first message frame, where the first message frame includes a first capability information element, the first capability information element includes first identification information, and the first identification information is used to indicate that the AP device supports non-orthogonal frequency division multiple access (non-OFDMA) uplink (UL) multi-user multiple-input multiple-output (MU-MIMO) communication on a 640 MHz bandwidth; and
a first transceiver unit, configured to send the first message frame.

In a fourth aspect, an embodiment of the present disclosure further provides a communication apparatus, and the apparatus includes:
a second determining unit, configured to determine a second message frame, where the second message frame includes a second capability information element, the second capability information element includes fifth identification information, and the fifth identification information is used to indicate that a STA device supports non-OFDMA UL MU-MIMO communication on a 640 MHz bandwidth; and
a second transceiver unit, configured to send the second message frame.

In a fifth aspect, an embodiment of the present disclosure further provides an access point (AP) device, including a memory, a processor, and a computer program stored in the memory and executable on the processor, where the processor, when executing the program, implements the communication method provided in the first aspect of the embodiments of the present disclosure.

In a sixth aspect, an embodiment of the present disclosure further provides a station (STA) device, including a memory, a processor, and a computer program stored in the memory and executable on the processor, where the processor, when executing the program, implements the communication method provided in the second aspect of the embodiments of the present disclosure.

In a seventh aspect, an embodiment of the present disclosure further provides a computer-readable storage medium, on which a computer program is stored, and the computer program, when being executed by a processor, implements any one of the communication methods provided in the embodiments of the present disclosure.

In the embodiments of the present disclosure, a communication manner for an AP device and a STA device to indicate the supported bandwidth in non-OFDMA UL MU-MIMO communication may be provided.

Additional aspects and advantages of the embodiments of the present disclosure will be partially provided in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the accompanying drawings that are to be used in the description of the embodiments of the present disclosure will be briefly introduced below. Obviously, the drawings in the following description are only some embodiments of the present disclosure, and those of ordinary skill in the art may obtain other drawings based on these drawings without paying creative effort.

FIG. 1 is a schematic flowchart of a communication method provided by an embodiment of the present disclosure;

FIG. 2 is another schematic flowchart of a communication method provided by an embodiment of the present disclosure;

FIG. 3 is a schematic structural diagram of a communication apparatus provided by an embodiment of the present disclosure;

FIG. 4 is another schematic structural diagram of a communication apparatus provided by an embodiment of the present disclosure; and

FIG. 5 is a schematic structural diagram of an electronic device provided by an embodiment of the present disclosure.

### DETAILED DESCRIPTION

In the embodiments of the present disclosure, the term “and/or” describes association relationship of associated objects, indicating that there may be three types of relationships. For example, A and/or B may indicate three cases where A exists alone, A and B exist at the same time, and B exists alone. The character “/” generally indicates that the related objects before and after this character are in an “or” relationship.

The term “a plurality of” in the embodiments of the present disclosure refers to two or more than two, and other quantifiers are similar thereto.

The exemplary embodiments will be described in detail herein, examples of which are shown in the accompanying drawings. When the drawings are involved in the following description, the same numbers in different drawings represent the same or similar elements, unless otherwise indicated. The embodiments described in the following illustrative embodiments do not represent all embodiments consistent with the present disclosure. Instead, they are merely examples of apparatuses and methods consistent with some of aspects of the present disclosure as detailed in the appended claims.

The terms used in the present disclosure are for the purpose of describing specific embodiments only and are not intended to restrict the present disclosure. The singular forms of “a”, “said” and “the” used in the present disclosure and the appended claims are also intended to include plural forms unless the context clearly indicates otherwise. It should also be understood that the term “and/or” used herein refers to and includes any or all possible combinations of one or more associated items listed.

It should be understood that although the terms of first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the wording “if used herein may be interpreted as “at the time of . . . ” or “when . . . ” or “in response to determining”.

A clear and complete description of technical solutions in the embodiments of the present disclosure will be provided below with reference to the drawings in the embodiments of the present disclosure. Obviously, the described embodiments are only a part of the embodiments of the present disclosure, but not all of the embodiments. Based on the embodiments in the present disclosure, all other embodiments obtained by those of ordinary skill in the art without paying creative effort fall within the protection scope of the present disclosure.

The method and the apparatus are based on the same disclosed concept. Since the principles for the method and apparatus to solve the problem are similar, the implementations of the apparatus and the method may be referred to each other, and the repeated parts will not be repeated.

The AP device is a wireless switch used for a wireless network and also an access device of the wireless network. The AP device may include software applications and/or circuits, enabling other types of nodes in the wireless network to communicate with the outside and inside of the wireless network through the AP. As an example, an AP device may be a terminal device or a network device equipped with a Wi-Fi chip.

The STA device may include, but is not limited to: a cellular phone, a smartphone, a wearable device, a computer, a personal digital assistant (PDA), a personal communication system (PCS) device, a personal information manager (PIM), a personal navigation device (PND), a global positioning system, a multimedia device, an Internet of Things (IOT) device, etc.

In order to improve the throughput of the system, it is usually necessary to increase the transmission bandwidth. However, in the existing standards, access point (AP) devices only support a maximum bandwidth of 320 MHz. If support for additional frequency bands is required, such capability needs to be indicated through relevant signaling.

Embodiments of the present disclosure provide a communication method and apparatus, a device, and a storage medium, which may provide a communication manner for indicating a bandwidth supported by an AP device and a STA device in non-OFDMA UL MU-MIMO communication.

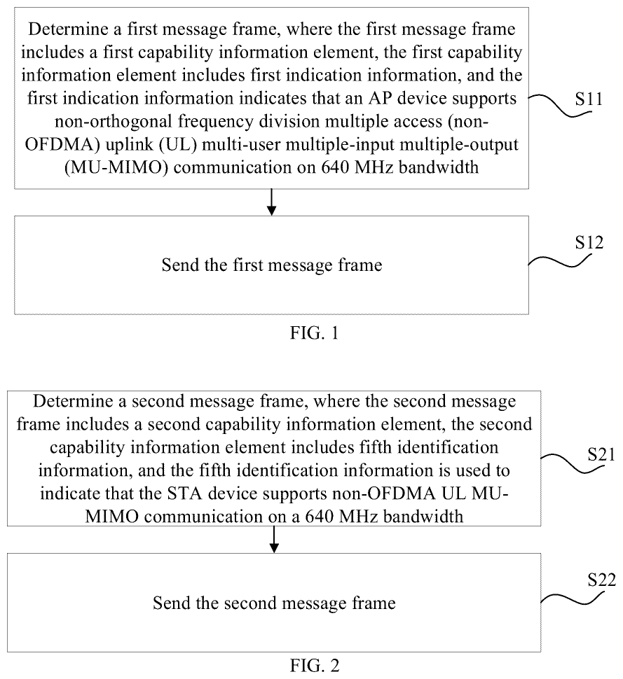

A communication method provided by an embodiment of the present disclosure may be specifically referred to FIG. 1. FIG. 1 is a schematic flowchart of the communication method provided by the embodiment of the present disclosure.

In some embodiments, the method may be applied to an AP device. The method may include the following steps.

In step S11, a first message frame is determined, where the first message frame includes a first capability information element, the first capability information element includes first identification information, and the first identification information is used to indicate that the AP device supports non-OFDMA UL MU-MIMO communication on a 640 MHz bandwidth.

The first message frame indicates, through the first identification information in the first capability information element, that the access point (AP) device supports the reception of non-orthogonal frequency division multiple access (non-OFDMA) uplink multi-user multiple-input multiple-output (MU-MIMO) on the 640 MHz bandwidth.

The first identification information includes at least one bit, and indicates that the AP device supports non-OFDMA UL MU-MIMO communication on the 640 MHz bandwidth through an independent identification value. Specifically, it may indicate that the AP device is capable of receiving physical layer protocol data units (PPDUs) of 640 MHz transmitted by multiple users simultaneously via different spatial streams (SSs). For example, if the first identification information in the first capability information element is set to 1, it indicates that the AP device supports non-OFDMA UL MU-MIMO communication in the 640 MHz bandwidth.

In step S12, the first message frame is sent.

After the first message frame is determined, the first message frame is sent to a station (STA) device.

In the communication method applied to the access point (AP) device provided by the present disclosure, the first capability information element further includes second identification information, and the second identification information is used to indicate that the AP device supports non-OFDMA UL MU-MIMO communication on a 480 MHz bandwidth.

The second identification information includes at least one bit, and indicates that the AP device supports non-OFDMA UL MU-MIMO communication on the 480 MHz bandwidth through an independent identification value. Specifically, the second identification information may indicate that the AP device is capable of receiving PPDUs of 480 MHz transmitted by multiple users simultaneously using different spatial streams. For example, if the second identification information in the first capability information element is set to 1, it indicates that the AP device supports non-OFDMA UL MU-MIMO communication on the 480 MHz bandwidth.

As an example, the first message frame includes the first capability information element, and the first capability information element includes the first identification information and the second identification information. The first identification information is used to indicate that the AP device supports non-OFDMA UL MU-MIMO communication on the 640 MHZ bandwidth, and the second identification information is used to indicate that the AP device supports non-OFDMA UL MU-MIMO communication on the 480 MHz bandwidth.

The 480 MHz bandwidth supported by the AP device may be a continuous 320 MHz+160 MHz bandwidth, and the 640 MHz bandwidth supported by the AP device may be a continuous 320 MHz+320 MHz bandwidth.

When the identification values of both the first identification information and the second identification information in the first capability information element are 1, it indicates that the AP device supports non-OFDMA UL MU-MIMO communication on the 640 MHz bandwidth and the 480 MHz bandwidth.

In the communication method applied to the access point (AP) device provided in the present disclosure, the first capability information element further includes third identification information, and the third identification information is used to indicate a maximum number of a long training field (LTF) supported by the AP device in non-OFDMA UL MU-MIMO communication.

The LTF is a UHR LTF.

The maximum number of the UHR LTF supported by the AP device in non-OFDMA UL MU-MIMO communication is the maximum number of the UHR LTF in the PPDU of non-OFDMA UL MU-MIMO communication.

The third identification information may indicate the maximum number of the UHR LTF supported by the AP device in non-OFDMA UL MU-MIMO communication through at least one bit, such as indicating the maximum number of the UHR LTF supported by the AP device in non-OFDMA UL MU-MIMO communication through two bits.

In some embodiments, the maximum number of the UHR LTF supported by the AP device in non-OFDMA UL MU-MIMO communication may be 8, 16 or 32, which is not limited herein.

In the communication method applied to the access point (AP) device provided in the present disclosure, the first capability information element further includes fourth identification information, and the fourth identification information is used to indicate a maximum number of the spatial stream supported by the AP device in non-OFDMA UL MU-MIMO communication.

The maximum number of the spatial stream supported by the AP device in non-OFDMA UL MU-MIMO communication is the maximum number of received spatial streams supported by the AP device in non-OFDMA UL MU-MIMO communication.

The fourth identification information may indicate, through at least one bit, the maximum number of the spatial stream supported by the AP device in non-OFDMA UL MU-MIMO communication.

In the communication method applied to the access point (AP) device provided by the present disclosure, the first message frame includes a first ultra high reliability capability information element (UHR Capabilities Information), and the first ultra high reliability capability information element includes the first capability information element.

That is, the first message frame includes a first ultra high reliability capability information element, the first ultra high reliability capability information element includes a first capability information element, and the first capability information element specifically further includes first identification information for indicating that the AP device supports non-OFDMA UL MU-MIMO communication on a 640 MHz bandwidth.

In some embodiments, the first capability information element may further include second identification information used to indicate that the AP device supports non-OFDMA UL MU-MIMO communication on a 480 MHz bandwidth.

In some embodiments, the first capability information element may further include third identification information used to indicate the maximum number of the UHR LTF supported by the AP device in non-OFDMA UL MU-MIMO communication.

In some embodiments, the first capability information element may further include fourth identification information used to indicate the maximum number of the spatial stream supported by the AP device in non-OFDMA UL MU-MIMO communication.

In the communication method applied to the access point (AP) device provided by the present disclosure, the first capability information element is a first physical layer capability information element (PHY Capabilities Information).

In the communication method applied to the access point (AP) device provided by the present disclosure, the AP device may further receive a second message frame.

The second message frame is determined and sent by the STA device.

The second capability information element includes fifth identification information, and the fifth identification information is used to indicate that the STA device supports non-OFDMA UL MU-MIMO communication on a 640 MHz bandwidth.

That is, the second message frame indicates through the fifth identification information in the second capability information element that the STA device supports non-OFDMA UL MU-MIMO communication on the 640 MHz bandwidth, that is, supports the reception and transmission of non-OFDMA UL MU-MIMO on the 640 MHz bandwidth.

The fifth identification information includes at least one bit, and indicates that the STA device supports non-OFDMA UL MU-MIMO communication on the 640 MHz bandwidth through an independent identification value. Specifically, it may indicate that the STA device is capable of receiving and sending PPDUs of 640 MHz transmitted by multiple users simultaneously via different spatial streams. For example, if the fifth identification information in the second capability information element is set to 1, it indicates that the STA device supports non-OFDMA UL MU-MIMO communication on the 640 MHz bandwidth.

In the communication method applied to the access point (AP) device provided by the present disclosure, the second capability information element further includes sixth identification information, and the sixth identification information is used to indicate that the STA device supports non-OFDMA UL MU-MIMO communication on a 480 MHz bandwidth.

The sixth identification information includes at least one bit, and indicates that the STA device supports non-OFDMA UL MU-MIMO communication on the 480 MHz bandwidth through an independent identification value. Specifically, it may indicate that the STA device is capable of receiving and sending PPDUs of 480 MHz transmitted by multiple users simultaneously via different spatial streams. For example, if the sixth identification information in the second capability information element is set to 1, it indicates that the STA device supports non-OFDMA UL MU-MIMO communication on the 480 MHz bandwidth.

As an example, the second message frame includes a second capability information element, and the second capability information element includes fifth identification information and sixth identification information. The fifth identification information is used to indicate that the STA device supports non-OFDMA UL MU-MIMO communication on a 640 MHz bandwidth, and the sixth identification information is used to indicate that the STA device supports non-OFDMA UL MU-MIMO communication on a 480 MHz bandwidth.

For example, when the identification values of both the fifth identification information and the sixth identification information in the second capability information element are 1, it indicates that the STA device supports non-OFDMA UL MU-MIMO communication on the 640 MHz and 480 MHz bandwidths.

In the communication method applied to the access point (AP) device provided by the present disclosure, the second capability information element further includes seventh identification information, and the seventh identification information is used to indicate a maximum number of UHR LTFs supported by the STA device in non-OFDMA UL MU-MIMO communication.

The maximum number of UHR LTFs supported by the STA device in non-OFDMA UL MU-MIMO communication is the maximum number of UHR LTFs in the PPDU of non-OFDMA UL MU-MIMO communication.

The seventh identification information may indicate the maximum number of UHR LTFs supported by the STA device in non-OFDMA UL MU-MIMO communication through at least one bit, such as indicating the maximum number of UHR LTFs supported by the STA device in non-OFDMA UL MU-MIMO communication through two bits.

In some embodiments, the maximum number of UHR LTFs supported by the STA device in non-OFDMA UL MU-MIMO communication may be 8, 16 or 32, which is not limited herein.

In the communication method applied to the access point (AP) device provided by the present disclosure, the second capability information element further includes eighth identification information, and the eighth identification information is used to indicate a maximum number of spatial streams (SSs) supported by the STA device in non-OFDMA UL MU-MIMO communication.

The maximum number of spatial streams supported by the STA device in non-OFDMA UL MU-MIMO communication is the maximum number of received spatial streams supported by the STA device in non-OFDMA UL MU-MIMO communication.

The eighth identification information may indicate, through at least one bit, the maximum number of spatial streams supported by the STA device in non-OFDMA UL MU-MIMO communication.

In the communication method applied to the access point (AP) device provided in the present disclosure, the second message frame includes a second ultra high reliability capability information element (UHR Capabilities Information), the second ultra high reliability capability information element includes the second capability information element.

That is, the second message frame includes a second ultra high reliability capability information element, the second ultra high reliability capability information element includes a second capability information element, and the second capability information element specifically further includes fifth identification information for indicating that the STA device supports non-OFDMA UL MU-MIMO communication on a 640 MHz bandwidth.

In some embodiments, the second capability information element may further include sixth identification information used to indicate that the STA device supports non-OFDMA UL MU-MIMO communication on a 480 MHz bandwidth.

In some embodiments, the second capability information element may further include seventh identification information used to indicate the maximum number of UHR LTFs supported by the STA device in non-OFDMA UL MU-MIMO communication.

In some embodiments, the second capability information element may further include eighth identification information used to indicate the maximum number of spatial streams supported by the STA device in non-OFDMA UL MU-MIMO communication.

In the communication method applied to the access point (AP) device provided by the present disclosure, the second capability information element is a second physical layer capability information element (PHY Capabilities Information).

In the communication method applied to the access point (AP) device provided in the present disclosure, the first message frame is at least one of a beacon frame, a probe response frame, or an association response frame.

As an example, the AP device sends a beacon frame, where the beacon frame includes first identification information, and the first identification information is used to indicate that the AP device supports non-OFDMA UL MU-MIMO communication on a 640 MHZ bandwidth.

In the communication method applied to the access point (AP) device provided by the present disclosure, the second message frame is at least one of a probe request frame or an association request frame.

As an example, the AP device receives a probe request frame, where the probe request frame includes fifth identification information, where the fifth identification information is used to indicate that the STA device supports non-OFDMA UL MU-MIMO communication on a 640 MHz bandwidth.

In the communication method applied to the access point (AP) device provided by the present disclosure, the AP device supports non-OFDMA UL MU-MIMO communication on the 640 MHz bandwidth, specifically, it may support non-OFDMA UL MU-MIMO communication on a continuous 320 MHz+320 MHz bandwidth. The AP device supports non-OFDMA UL MU-MIMO communication on the 480 MHz bandwidth, specifically, it may support non-OFDMA UL MU-MIMO communication on a continuous 320 MHz+160 MHz bandwidth.

The STA device supports non-OFDMA UL MU-MIMO communication on the 640 MHz bandwidth, specifically, it may support non-OFDMA UL MU-MIMO communication on a continuous 320 MHz+320 MHz bandwidth. The STA device supports non-OFDMA UL MU-MIMO communication on the 480 MHz bandwidth, specifically, it may support non-OFDMA UL MU-MIMO communication on a continuous 320 MHz+160 MHz bandwidth.

In the communication method applied to the access point (AP) device provided in the present disclosure, the first capability information element further includes ninth identification information, and the ninth identification information is used to indicate that the AP device supports OFDMA communication or Non-OFDMA communication.

In the communication method applied to the access point (AP) device provided in the present disclosure, the second capability information element further includes tenth identification information, and the tenth identification information is used to indicate that the STA device supports OFDMA communication or Non-OFDMA communication.

A communication method provided by an embodiment of the present disclosure may be specifically referred to FIG. 2, which is another schematic flowchart of the communication method provided by the embodiment of the present disclosure.

In some embodiments, the method may be applied to a STA device. The method may include the following steps:
In step S21, a second message frame is determined, where the second message frame includes a second capability information element, the second capability information element includes fifth identification information, and the fifth identification information is used to indicate that the STA device supports non-OFDMA UL MU-MIMO communication on a 640 MHz bandwidth.

The second message frame indicates, through the fifth identification information in the second capability information element, that the STA device supports non-OFDMA UL MU-MIMO communication on the 640 MHz bandwidth, that is, it supports reception and transmission of non-OFDMA UL MU-MIMO on 640 MHz bandwidth.

The fifth identification information includes at least one bit, and indicates that the STA device supports non-OFDMA UL MU-MIMO communication on the 640 MHz bandwidth through an independent identification value. Specifically, it may indicate that the STA device is capable of receiving and sending 640 MHz PPDUs transmitted by multiple users simultaneously via different spatial streams. For example, if the fifth identification information in the second capability information element is set to 1, it indicates that the STA device supports non-OFDMA UL MU-MIMO communication on the 640 MHz bandwidth.

In step S22, the second message frame is sent.

After the second message frame is determined, the second message frame is sent to an AP device.

In the communication method applied to the station (STA) device provided by the present disclosure, the second capability information element further includes sixth identification information, and the sixth identification information is used to indicate that the STA device supports non-OFDMA UL MU-MIMO communication on a 480 MHz bandwidth.

The sixth identification information includes at least one bit, and indicates that the STA device supports non-OFDMA UL MU-MIMO communication on the 480 MHz bandwidth through an independent identification value. Specifically, it may indicate that the STA device is capable of receiving and sending 480 MHz PPDUs transmitted by multiple users simultaneously using different spatial streams. For example, if the sixth identification information in the second capability information element is set to 1, it indicates that the STA device supports non-OFDMA UL MU-MIMO communication on the 480 MHz bandwidth.

As an example, the second message frame includes the second capability information element, and the second capability information element includes the fifth identification information and the sixth identification information. The fifth identification information is used to indicate that the STA device supports non-OFDMA UL MU-MIMO communication on the 640 MHz bandwidth, and the sixth identification information is used to indicate that the STA device supports non-OFDMA UL MU-MIMO communication on the 480 MHz bandwidth.

For example, when the identification values of both the fifth identification information and the sixth identification information in the second capability information element are 1, it indicates that the STA device supports non-OFDMA UL MU-MIMO communication on 640 MHz and 480 MHz bandwidths.

The 480 MHz bandwidth supported by the STA device may be a continuous 320 MHz+160 MHz bandwidth, and the 640 MHz bandwidth supported by the STA device may be a continuous 320 MHz+320 MHz bandwidth.

In the communication method applied to the station (STA) device provided by the present disclosure, the second capability information element further includes seventh identification information, and the seventh identification information is used to indicate a maximum number of UHR LTFs supported by the STA device in non-OFDMA UL MU-MIMO communication.

The maximum number of UHR LTFs supported by the STA device in non-OFDMA UL MU-MIMO communication is the maximum number of UHR LTFs in the PPDU of non-OFDMA UL MU-MIMO communication.

The seventh identification information may indicate the maximum number of UHR LTFs supported by the STA device in non-OFDMA UL MU-MIMO communication through at least one bit, such as indicating the maximum number of UHR LTFs supported by the STA device in non-OFDMA UL MU-MIMO communication through two bits.

In some embodiments, the maximum number of UHR LTFs supported by the STA device in non-OFDMA UL MU-MIMO communication may be 8, 16 or 32, which is not limited herein.

In the communication method applied to the station (STA) device provided in the present disclosure, the second capability information element further includes eighth identification information, and the eighth identification information is used to indicate the maximum number of spatial streams supported by the STA device in non-OFDMA UL MU-MIMO communication.

The maximum number of spatial streams supported by the STA device in non-OFDMA UL MU-MIMO communication is the maximum number of received spatial streams supported by the STA device in non-OFDMA UL MU-MIMO communication.

The eighth identification information may indicate, through at least one bit, the maximum number of spatial streams supported by the STA device in non-OFDMA UL MU-MIMO communication.

In the communication method applied to the station (STA) device provided in the present disclosure, the first message frame includes a first ultra high reliability capability information element (UHR Capabilities Information), the first ultra high reliability capability information element includes the first capability information element.

That is, the second message frame includes a second ultra high reliability capability information element, the second ultra high reliability capability information element includes a second capability information element, and the second capability information element specifically further includes fifth identification information for indicating that the STA device supports non-OFDMA UL MU-MIMO communication on a 640 MHz bandwidth.

In some embodiments, the second capability information element may further include sixth identification information used to indicate that the STA device supports non-OFDMA UL MU-MIMO communication on a 480 MHz bandwidth.

In some embodiments, the second capability information element may further include seventh identification information used to indicate the maximum number of UHR LTFs supported by the STA device in non-OFDMA UL MU-MIMO communication.

In some embodiments, the second capability information element may further include eighth identification information used to indicate the maximum number of spatial streams supported by the STA device in non-OFDMA UL MU-MIMO communication.

In the communication method applied to the station (STA) device provided by the present disclosure, the second capability information element is a second physical layer capability information element (PHY Capabilities Information).

In the communication method applied to the state (STA) device provided in the present disclosure, the STA device may further receive a first message frame sent by the AP device.

The first message frame includes a first capability information element.

The first capability information element includes first identification information, and the first identification information is used to indicate that the AP device supports non-OFDMA UL MU-MIMO communication on a 640 MHz bandwidth.

That is, the first message frame indicates, through the first identification information in the first capability information element, that the access point (AP) device supports non-OFDMA UL MU-MIMO communication on the 640 MHz bandwidth, i.e., supports reception of non-OFDMA UL MU-MIMO on the 640 MHz bandwidth.

The first identification information includes at least one bit, and indicates that the AP device supports non-OFDMA UL MU-MIMO communication on the 640 MHz bandwidth through an independent identification value. Specifically, it may indicate that the AP device is capable of receiving PPDUs of 640 MHz transmitted by multiple users simultaneously via different spatial streams. For example, when the first identification information in the first capability information element is set to 1, it indicates that the AP device supports non-OFDMA UL MU-MIMO communication on the 640 MHz bandwidth.

In the communication method applied to the station (STA) device provided in the present disclosure, the first capability information element further includes second identification information, and the second identification information is used to indicate that the AP device supports non-OFDMA UL MU-MIMO communication on a 480 MHz bandwidth.

The second identification information includes at least one bit, and indicates that the AP device supports non-OFDMA UL MU-MIMO communication on the 480 MHz bandwidth through an independent identification value. Specifically, it may indicate that the AP device is capable of receiving PPDUs of 480 MHz transmitted by multiple users simultaneously via different spatial streams. For example, if the second identification information in the first capability information element is set to 1, it indicates that the AP device supports non-OFDMA UL MU-MIMO communication on the 480 MHz bandwidth.

As an example, the first message frame includes the first capability information element, and the first capability information element includes the first identification information and the second identification information. The first identification information is used to indicate that the AP device supports non-OFDMA UL MU-MIMO communication on the 640 MHZ bandwidth, and the second identification information is used to indicate that the AP device supports non-OFDMA UL MU-MIMO communication on the 480 MHz bandwidth.

The 480 MHz bandwidth supported by the AP device may be a continuous 320 MHz+160 MHz bandwidth, and the 640 MHz bandwidth supported by the AP device may be a continuous 320 MHz+320 MHz bandwidth.

For example, when the identification values of both the first identification information and the second identification information in the first capability information element are 1, it indicates that the AP device supports non-OFDMA UL MU-MIMO communication on 640 MHz and 480 MHz bandwidths.

In the communication method applied to the station (STA) device provided in the present disclosure, the first capability information element further includes third identification information, and the third identification information is used to indicate a maximum number of UHR LTFs supported by the AP device in non-OFDMA UL MU-MIMO communication.

The maximum number of a UHR LTF supported by the AP device in non-OFDMA UL MU-MIMO communication is the maximum number of a UHR LTF in the physical layer protocol data unit (PPDU) of non-OFDMA UL MU-MIMO communication.

The third identification information may indicate the maximum number of a UHR LTF supported by the AP device in non-OFDMA UL MU-MIMO communication through at least one bit, such as indicating the maximum number of a UHR LTF supported by the AP device in non-OFDMA UL MU-MIMO communication through two bits.

In some embodiments, the maximum number of the UHR LTF supported by the AP device in non-OFDMA UL MU-MIMO communication may be 8, 16 or 32, which is not limited herein.

In the communication method applied to the station (STA) device provided in the present disclosure, the first capability information element further includes fourth identification information, and the fourth identification information is used to indicate the maximum number of a spatial stream supported by the AP device in non-OFDMA UL MU-MIMO communication.

The maximum number of the spatial stream supported by the AP device in non-OFDMA UL MU-MIMO communication is the maximum number of a received spatial stream supported by the AP device in non-OFDMA UL MU-MIMO communication.

The fourth identification information may indicate, through at least one bit, the maximum number of the spatial stream supported by the AP device in non-OFDMA UL MU-MIMO communication.

In the communication method applied to the station (STA) device provided in the present disclosure, the first message frame includes a first ultra high reliability capability information element, and the first ultra high reliability capability information element includes the first capability information element.

That is, the first message frame includes a first ultra high reliability capability information element, the first ultra high reliability capability information element includes a first capability information element, and the first capability information element specifically further includes first identification information for indicating that the AP device supports non-OFDMA UL MU-MIMO communication on a 640 MHz bandwidth.

In some embodiments, the first capability information element may further include second identification information used to indicate that the AP device supports non-OFDMA UL MU-MIMO communication on a 480 MHz bandwidth.

In some embodiments, the first capability information element may further include third identification information used to indicate the maximum number of UHR LTFs supported by the AP device in non-OFDMA UL MU-MIMO communication.

In some embodiments, the first capability information element may further include fourth identification information used to indicate the maximum number of spatial streams supported by the AP device in non-OFDMA UL MU-MIMO communication.

In the communication method applied to the station (STA) device provided by the present disclosure, the first capability information element is a first physical layer capability information element (PHY Capabilities Information).

In the communication method applied to the station (STA) device provided in the present disclosure, the first message frame is at least one of a beacon frame, a probe response frame, or an association response frame.

As an example, the STA device receives a beacon frame sent by the AP device, where the beacon frame includes first identification information, and the first identification information is used to indicate that the AP device supports non-OFDMA UL MU-MIMO communication on a 640 MHz bandwidth.

In the communication method applied to the station (STA) device provided in the present disclosure, the second message frame is at least one of a probe request frame or an association request frame.

As an example, the STA device sends a probe request frame to the AP device, where the probe request frame includes fifth identification information, where the fifth identification information is used to indicate that the STA device supports non-OFDMA UL MU-MIMO communication on a 640 MHz bandwidth.

In the communication method applied to the station (STA) device provided by the present disclosure, the AP device supports non-OFDMA UL MU-MIMO communication on the 640 MHz bandwidth, specifically, it may support non-OFDMA UL MU-MIMO communication in a continuous 320 MHz+320 MHz bandwidth. The AP device supports non-OFDMA UL MU-MIMO communication on the 480 MHz bandwidth, specifically, it may support non-OFDMA UL MU-MIMO communication in a continuous 320 MHz+160 MHz bandwidth.

The STA device supports non-OFDMA UL MU-MIMO communication on the 640 MHz bandwidth, specifically, it may support non-OFDMA UL MU-MIMO communication on a continuous 320 MHz+320 MHz bandwidth. The STA device supports non-OFDMA UL MU-MIMO communication on the 480 MHz bandwidth, specifically, it may support non-OFDMA UL MU-MIMO communication on a continuous 320 MHz+160 MHz bandwidth.

In the embodiments of the present disclosure, the AP device may indicate the bandwidth supported (such as 640 MHz) in non-OFDMA UL MU-MIMO communication through the first capability information element in the first message frame, and the STA device may indicate the bandwidth supported (such as 640 MHz) in non-OFDMA UL MU-MIMO communication through the second capability information element in the second message frame.

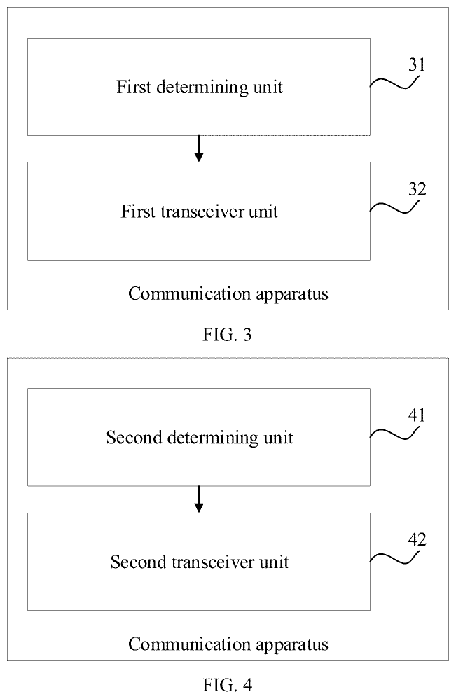

As shown in FIG. 3, an embodiment of the present disclosure provides a communication apparatus, including:
a first determining unit 31, configured to determine a first message frame, where the first message frame includes a first capability information element, the first capability information element includes first identification information, and the first identification information is used to indicate that the communication apparatus supports non-OFDMA UL MU-MIMO communication on a 640 MHz bandwidth; and
a first transceiver unit 32, configured to send the first message frame.

Alternatively, in the embodiments of the present disclosure, the first capability information element further includes second identification information, and the second identification information is used to indicate that the AP device supports non-OFDMA UL MU-MIMO communication on a 480 MHz bandwidth.

Alternatively, in the embodiments of the present disclosure, the first message frame includes a first ultra high reliability capability information element, the first ultra high reliability capability information element includes the first capability information element, and the first capability information element is a first physical layer capability information element.

Alternatively, in the embodiments of the present disclosure, the first capability information element further includes third identification information, and the third identification information is used to indicate a maximum number of a long training field (LTF) supported by the AP device in non-OFDMA UL MU-MIMO communication.

Alternatively, in the embodiments of the present disclosure, the first capability information element further includes fourth identification information, and the fourth identification information is used to indicate a maximum number of a spatial stream (SS) supported by the AP device in non-OFDMA UL MU-MIMO communication.

Alternatively, in the embodiments of the present disclosure, the first transceiver unit 32 is further configured to:
receive a second message frame, where the second message frame includes a second capability information element, the second capability information element includes fifth identification information, and the fifth identification information is used to indicate that a STA device supports non-OFDMA UL MU-MIMO communication on the 640 MHz bandwidth.

Alternatively, in the embodiments of the present disclosure, the second capability information element further includes sixth identification information, and the sixth identification information is used to indicate that the STA device supports non-OFDMA UL MU-MIMO communication on a 480 MHz bandwidth.

Alternatively, in the embodiments of the present disclosure, the second message frame includes a second ultra high reliability capability information element, the second ultra high reliability capability information element includes the second capability information element, and the second capability information element is a second physical layer capability information element.

Alternatively, in the embodiments of the present disclosure, the second capability information element further includes seventh identification information, and the seventh identification information is used to indicate a maximum number of an LTF supported by the STA device in non-OFDMA UL MU-MIMO communication.

Alternatively, in the embodiments of the present disclosure, the second capability information element further includes eighth identification information, and the eighth identification information is used to indicate a maximum number of an SS supported by the STA device in non-OFDMA UL MU-MIMO communication.

Alternatively, in the embodiments of the present disclosure, the first message frame is at least one of a beacon frame, a probe response frame or an association response frame; and the second message frame is at least one of a probe request frame or an association request frame.

As shown in FIG. 4, an embodiment of the present disclosure provides a communication apparatus, including:
a second determining unit 41, configured to determine a second message frame, where the second message frame includes a second capability information element, the second capability information element includes fifth identification information, and the fifth identification information is used to indicate that the communication apparatus supports non-OFDMA UL MU-MIMO communication on a 640 MHz bandwidth; and a second transceiver unit 42, configured to send the second message frame.

Alternatively, in the embodiments of the present disclosure, the second capability information element further includes sixth identification information, and the sixth identification information is used to indicate that the STA device supports non-OFDMA UL MU-MIMO communication on a 480 MHz bandwidth.

Alternatively, in the embodiments of the present disclosure, the second message frame includes a second ultra high reliability capability information element, the second ultra high reliability capability information element includes the second capability information element, and the second capability information element is a second physical layer capability information element.

Alternatively, in the embodiments of the present disclosure, the second capability information element further includes seventh identification information, and the seventh identification information is used to indicate a maximum number of an LTF supported by the STA device in non-OFDMA UL MU-MIMO communication.

Alternatively, in the embodiments of the present disclosure, the second capability information element further includes eighth identification information, and the eighth identification information is used to indicate a maximum number of an SS supported by the STA device in non-OFDMA UL MU-MIMO communication.

Alternatively, in the embodiments of the present disclosure, the second transceiver unit 42 is further configured to:
receive a first message frame, where the first message frame includes a first capability information element, the first capability information element includes first identification information, and the first identification information is used to indicate that an AP device supports non-OFDMA UL MU-MIMO communication on the 640 MHz bandwidth.

Alternatively, in the embodiments of the present disclosure, the first capability information element further includes second identification information, and the second identification information is used to indicate that the AP device supports non-OFDMA UL MU-MIMO communication on a 480 MHz bandwidth.

Alternatively, in the embodiments of the present disclosure, the first message frame includes a first ultra high reliability capability information element, the first ultra high reliability capability information element includes the first capability information element, and the first capability information element is a first physical layer capability information element.

Alternatively, in the embodiments of the present disclosure, the first capability information element further includes third identification information, and the third identification information is used to indicate a maximum number of an LTF supported by the AP device in non-OFDMA UL MU-MIMO communication.

Alternatively, in the embodiments of the present disclosure, the first capability information element further includes fourth identification information, and the fourth identification information is used to indicate a maximum number of an SS supported by the AP device in non-OFDMA UL MU-MIMO communication.

Alternatively, in the embodiments of the present disclosure, the first message frame is at least one of a beacon frame, a probe response frame or an association response frame; and the second message frame is at least one of a probe request frame or an association request frame.

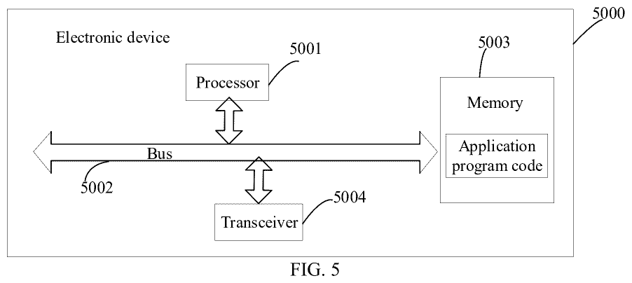

An embodiment of the present disclosure further provides an electronic device, as shown in FIG. 5. The electronic device 5000 shown in FIG. 5 includes a processor 5001 and a memory 5003. The processor 5001 and the memory 5003 are connected, for example, via a bus 5002. Alternatively, the electronic device 5000 may further include a transceiver 5004. It should be noted that in practical applications, the number of the transceiver 5004 is not limited to one, and the structure of the electronic device 5000 does not constitute a limitation of the embodiments of the present disclosure.

The memory 5003 is used to store the application program code for executing the embodiments of the present disclosures, and the execution of the application program code is controlled by the processor 5001. When the electronic device 5000 functions as an AP device, the processor 5001 executes the application program code stored in the memory 5003 to implement the communication method applicable to the AP device in this solution. When the electronic device 5000 functions as an STA device, the processor 5001 executes the application program code stored in the memory 5003 to implement the communication method applicable to the STA device in this solution.

The bus 5002 may include a path for transmitting information between the above components. The bus 5002 may be a Peripheral Component Interconnect (PCI) bus or an Extended Industry Standard Architecture (EISA) bus, or the like. The bus 5002 may be divided into an address bus, a data bus, a control bus, etc. For ease of representation, only one thick line is used in FIG. 5 for indicating the bus, but it does not indicate that there is only one bus or only one type of bus.

The memory 5003 may be a Read Only Memory (ROM) or other types of static storage devices that may store static information and instructions, a Random Access Memory (RAM) or other types of dynamic storage devices that may store information and instructions, or an Electrically Erasable Programmable Read Only Memory (EEPROM), a Compact Disc Read Only Memory (CD-ROM) or other optical disk storage, optical disc storage (including compact optical disc, laser disc, optical disc, digital versatile optical disc, Blu-ray disc, etc.), a magnetic disk storage medium or other magnetic storage device, or any other medium that may be used to carry or store desired program code in the form of instructions or data structures and may be accessed by a computer, but is not limited thereto.

An embodiment of the present disclosure provides a computer-readable storage medium on which a computer program is stored, when being run on a computer, causes the computer to execute the corresponding contents in the above method embodiments.

It should be understood that, although the steps in the flowcharts of the accompanying drawings are shown in sequence as indicated by the arrows, these steps are not necessarily performed sequentially in the order as indicated by the arrows. There is no strict restriction on the performing order of these steps, and they may be performed in other orders, unless otherwise stated herein. Moreover, at least a part of the steps in the flowcharts of the accompanying drawings may include multiple sub-steps or multiple stages, and these sub-steps or stages are not necessarily completed at the same time, but may be performed at different times, and the performing order thereof is not necessarily sequential, but may be performed in turn or alternately with other steps or at least a part of the sub-steps or stages of other steps.

It should be noted that the computer-readable medium mentioned above in the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but is not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, apparatus or device. In the present disclosure, the computer-readable signal medium may include a data signal propagated in a baseband or as part of a carrier wave, which carries computer-readable program code. The propagated data signal may take a variety of forms, including but not limited to electromagnetic signals, optical signals, or any suitable combination of the above. The computer readable signal medium may also be any computer readable medium other than the computer readable storage medium, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The above computer-readable storage medium may be included in the above AP device or STA device, or may exist independently without being assembled into the AP device or the STA device.

The above computer-readable storage medium carries one or more programs which, when being executed by the AP device or the STA device, cause the AP device or the STA device to perform the corresponding communication method.

According to an aspect of the present disclosure, a computer program product or a computer program is provided, the computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the methods provided in the above various optional implementations.

The computer program code for performing the operations of the present disclosure may be written in one or more programming languages, or a combination thereof, including object-oriented programming languages, such as Java, Smalltalk, C++, and conventional procedural programming languages, such as “C” language or similar programming languages. The program code may be executed entirely on the user's computer, partially executed on the user's computer, executed as a separate software package, executed partially on the user's computer and partially on a remote computer, or executed entirely on a remote computer or server. In the cases involving a remote computer, the remote computer may be connected to the user's computer through any type of network, including a local area network (LAN) or a wide area network (WAN), or may be connected to an external computer (e.g., via Internet using an Internet service provider).

The flow charts and block diagrams in the accompanying drawings illustrate the possible architectures, functions and operations of the system, method and computer program product according to various embodiments of the present disclosure. In this regard, each of the blocks in the flow charts or block diagrams may represent a module, a program segment or part of code, and the module, the program segment or the part of code contains one or more executable instructions for realizing the specified logical functions. It should also be noted that in some alternative implementations, the functions marked in the blocks may also occur in a sequence different from that marked in the accompanying drawings. For example, two blocks shown in succession may actually be executed substantially in parallel, or they may sometimes be executed in the opposite order, depending on the functions involved. It should also be noted that each block in the block diagrams and/or flow charts, and the combination of the blocks in the block diagrams and/or flow charts may be implemented with a dedicated hardware-based system that performs a specified function or operation, or may be implemented with a combination of dedicated hardware and computer instructions.

The modules involved in the embodiments described in the present disclosure may be implemented in software or in hardware. The names of the modules do not make limitation on the modules themselves in some cases. For example, a module A may also be described as “a module A for performing operation B”.

Those described above are only explanations of preferred embodiments of the present disclosure and the technical principles employed. Those skilled in the art should understand that the scope of disclosure involved in the present disclosure is not limited to the technical solutions formed by the above specific combination of the technical features, but should also cover other technical solutions formed by any combination of the above technical features or their equivalent features without departing from the above disclosed concept, for example, a technical solution formed by replacing the above features with the technical features with similar functions disclosed in the present disclosure (but not limited to).

1. A communication method, applied to an access point (AP) device, comprising:
determining a first message frame, wherein the first message frame comprises a first capability information element, the first capability information element comprises first identification information, and the first identification information indicates that the AP device supports non-orthogonal frequency division multiple access (non-OFDMA) uplink (UL) multi-user multiple-input multiple-output (MU-MIMO) communication on a 640 MHz bandwidth; and
sending the first message frame.

2. The method according to claim 1, wherein the first capability information element further comprises second identification information, and the second identification information indicates that the AP device supports non-OFDMA UL MU-MIMO communication on a 480 MHz bandwidth.

3. The method according to claim 2, wherein the first message frame comprises a first ultra high reliability capability information element, the first ultra high reliability capability information element comprises the first capability information element, and the first capability information element is a first physical layer capability information element.

4. The method according to claim 1, wherein the first capability information element further comprises third identification information, and the third identification information indicates a maximum number of a long training field (LTF) supported by the AP device in non-OFDMA UL MU-MIMO communication.

5. The method according to claim 1, wherein the first capability information element further comprises fourth identification information, and the fourth identification information indicates a maximum number of a spatial stream (SS) supported by the AP device in non-OFDMA UL MU-MIMO communication.

6. The method according to claim 1, further comprising:
receiving a second message frame, wherein the second message frame comprises a second capability information element, the second capability information element comprises fifth identification information, and the fifth identification information indicates that a STA device supports the non-OFDMA UL MU-MIMO communication on the 640 MHz bandwidth.

7. The method according to claim 6, wherein the second capability information element further comprises sixth identification information, and the sixth identification information indicates that the STA device supports non-OFDMA UL MU-MIMO communication on a 480 MHz bandwidth.

8. The method according to claim 6, wherein the second message frame comprises a second ultra high reliability capability information element, the second ultra high reliability capability information element comprises the second capability information element, and the second capability information element is a second physical layer capability information element.

9. The method according to claim 6, wherein the second capability information element further comprises seventh identification information, and the seventh identification information indicates a maximum number of an LTF supported by the STA device in non-OFDMA UL MU-MIMO communication.

10. The method according to claim 6, wherein the second capability information element further comprises eighth identification information, and the eighth identification information indicates a maximum number of an SS supported by the STA device in non-OFDMA UL MU-MIMO communication.

11. The method according to claim 6, wherein the first message frame is at least one of a beacon frame, a probe response frame or an association response frame; and the second message frame is at least one of a probe request frame or an association request frame.

12. A communication method, applied to a station (STA) device, comprising:
determining a second message frame, wherein the second message frame comprises a second capability information element, the second capability information element comprises fifth identification information, and the fifth identification information indicates that the STA device supports non-OFDMA UL MU-MIMO communication on a 640 MHz bandwidth; and
sending the second message frame.

13. The method according to claim 12, wherein the second capability information element further comprises sixth identification information, and the sixth identification information indicates that the STA device supports non-OFDMA UL MU-MIMO communication on a 480 MHz bandwidth.

14. The method according to claim 13, wherein the second message frame comprises a second ultra high reliability capability information element, the second ultra high reliability capability information element comprises the second capability information element, and the second capability information element is a second physical layer capability information element.

15.-16. (anceled)

17. The method according to claim 12, wherein the method comprises:
receiving a first message frame, wherein the first message frame comprises a first capability information element, the first capability information element comprises first identification information, and the first identification information indicates that an AP device supports the non-OFDMA UL MU-MIMO communication on the 640 MHz bandwidth.

18. The method according to claim 17, wherein the first capability information element further comprises second identification information, and the second identification information indicates that the AP device supports non-OFDMA UL MU-MIMO communication on a 480 MHz bandwidth.

19. The method according to claim 17, wherein the first message frame comprises a first ultra high reliability capability information element, the first ultra high reliability capability information element comprises the first capability information element, and the first capability information element is a first physical layer capability information element.

20.-21. (canceled)

22. The method according to claim 17, wherein the first message frame is at least one of a beacon frame, a probe response frame or an association response frame; and the second message frame is at least one of a probe request frame or an association request frame.

23.-24. (canceled)

25. An access point (AP) device, comprising a memory, a processor, and a computer program stored in the memory and executable on the processor, wherein the processor, when executing the program, implements:
determining a first message frame, wherein the first message frame comprises first capability information element, the first capability information element comprises first identification information, and the first identification information is used to indicate that the AP device supports non-OFDMA UL MU-MIMO communication on a 640 MHZ bandwidth; and
sending the first message frame.

26. A station (STA) device, comprising a memory, a processor and a computer program stored in the memory and executable on the processor, wherein the processor, when executing the program, implements the method according to claim 12.

27. (canceled)
